(19) United States
(12) Patent Application Publication
(10) Pub. No.: US 2022/0148053 A1
(43) Pub. Date: May 12, 2022

(54) SYSTEMS AND METHODS FOR PERSISTENT ON DEMAND PAYMENTS

(71) Applicant: Billfire, LLC, Scottsdale, AZ (US)

(72) Inventors: John Lockhart, Scottsdale, AZ (US); Wally Thornton, Scottsdale, AZ (US)

(73) Assignee: Billfire, LLC, Scottsdale, AZ (US)

(21) Appl. No.: 17/522,718

(22) Filed: Nov. 9, 2021

Related U.S. Application Data
(60) Provisional application No. 63/112,413, filed on Nov. 11, 2020.

(51) Int. Cl. G06Q 30/04; G06Q 20/36

(52) U.S. Cl. CPC G06Q 30/04; G06Q 20/363

(57) ABSTRACT

A system for persistent on demand payments is disclosed. The system may create a customizable payment event, generate a first event token linked to the customizable payment event, transmit the first event token to a user device, receive at least one of a payment channel data or a dispute data, and update the customizable payment event based on at least one of the payment channel data or the dispute data.

### CROSS REFERENCE TO RELATED APPLICATIONS

This application claims priority to, and the benefit of, U.S. Provisional Patent Application Ser. No. 63/112,413 filed on Nov. 11, 2020 entitled “SYSTEMS AND METHODS FOR PERSISTENT ON DEMAND PAYMENTS”, the disclosure of which is hereby incorporated by reference in their entirety.

### FIELD

This disclosure generally relates to payments system and, more particularly, to persistent on demand payments systems including user configurable rules.

### BACKGROUND

Computers and computer software have long been used for accounting purposes. Accounting and closely monitoring activity of commercial customers is an integral part of any business. Monitoring sales, payments, outstanding requests for purchases, deliveries, ensuring all customers maintain their agreed upon terms, maintaining custom flexibility based on a customer history, and proactively requesting a specific payment to maintain a good customer relationship is all part and parcel of any goods and/or services business, with or without the use of computers.

Business to business transactions are generally based on a contractual relationship that dictates certain terms of a sale, price, payment expectations, delivery expectations, and the like. It is common for a seller to extend credit to a buyer. For example, delivery today and payment in thirty days. Sometimes, prior to that payment, other deliveries will be made on the same terms. Sometimes there are weekly deliveries, semi-weekly deliveries or random deliveries. If all deliveries carry with them the same terms, for example, in thirty days, deliveries and payments will not always be exactly coordinated. This can be referred to as open account selling. The buyer has an open account, requests and receives deliveries, and then has an ongoing obligation to make payments on that account consistent with the terms of the agreement with the seller. The seller may have many customers, each with their own terms dependent on the volume of sales, the history of on-time payments, essentially according to the risk the seller is willing to take with any particular buyer. Monitoring all of this can be a daunting task indeed.

### SUMMARY

A system, method, and computer readable medium (collectively, the “system”) is disclosed for persistent on demand payments. In various embodiments, the system may create a customizable payment event, generate a first event token linked to the customizable payment event, transmit the first event token to a user device, receive at least one of a payment channel data or a dispute data, and update the customizable payment event based on at least one of the payment channel data or the dispute data.

In various embodiments, the system may receive invoice data, determine a payable invoice based on the invoice data, associate the payable invoice with customer data, determine a payable amount and a payable date based on the payable invoice and the customer data, and create the customizable payment event in response to the payable invoice based on the customer data and the payable amount. In various embodiments, the system may display a user configurable payment event settings interface, receive payment event settings data, and update the customizable payment event based on the payment event settings data.

In various embodiments, the system may start at least one of a payment schedule process or a payment change process in response to the payment event settings data and generate a second event token linked to the customizable payment event and based on at least one of the payment schedule process or the payment change process. In various embodiments, the system may capture a payment event metadata, evaluate the payment event metadata, the payment event settings data, the customer data, and the invoice data to determine a targeted payment event, and generate a second event token linked to the customizable payment event and based on the targeted payment event.

In various embodiments, the payment event settings data includes at least one of a new payable date, a payment channel, a partial payment amount, or a reminder date. In various embodiments, the system may receive an autopayment enrollment request, start an autopayment process in response to the autopayment enrollment request, generate the first event token via the autopayment process, and execute a transaction based on the payment channel data.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION

The subject matter of the present disclosure is particularly pointed out and distinctly claimed in the concluding portion of the specification. However, a more complete understanding of the present disclosure may be obtained by referring to the detailed description and claims when considered in connection with the drawing figures, wherein like numerals denote like elements.

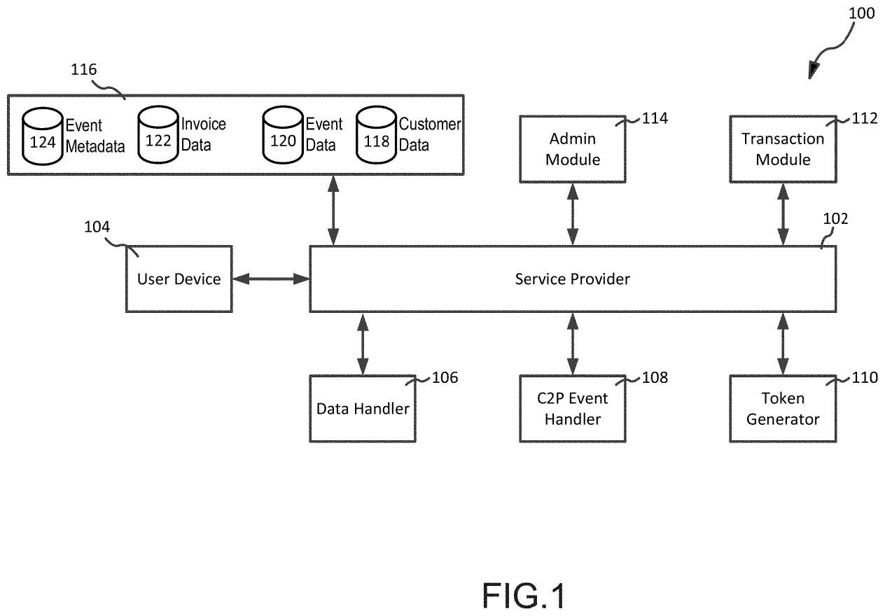

FIG. 1 is a block diagram illustrating a system for persistent on demand payments, in accordance with various embodiments;

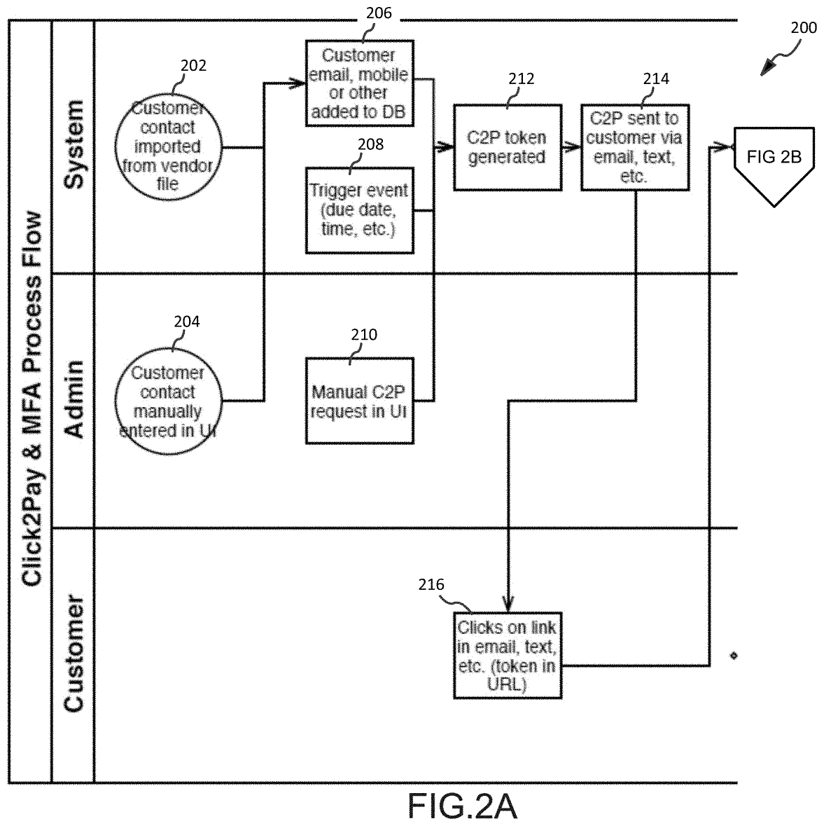

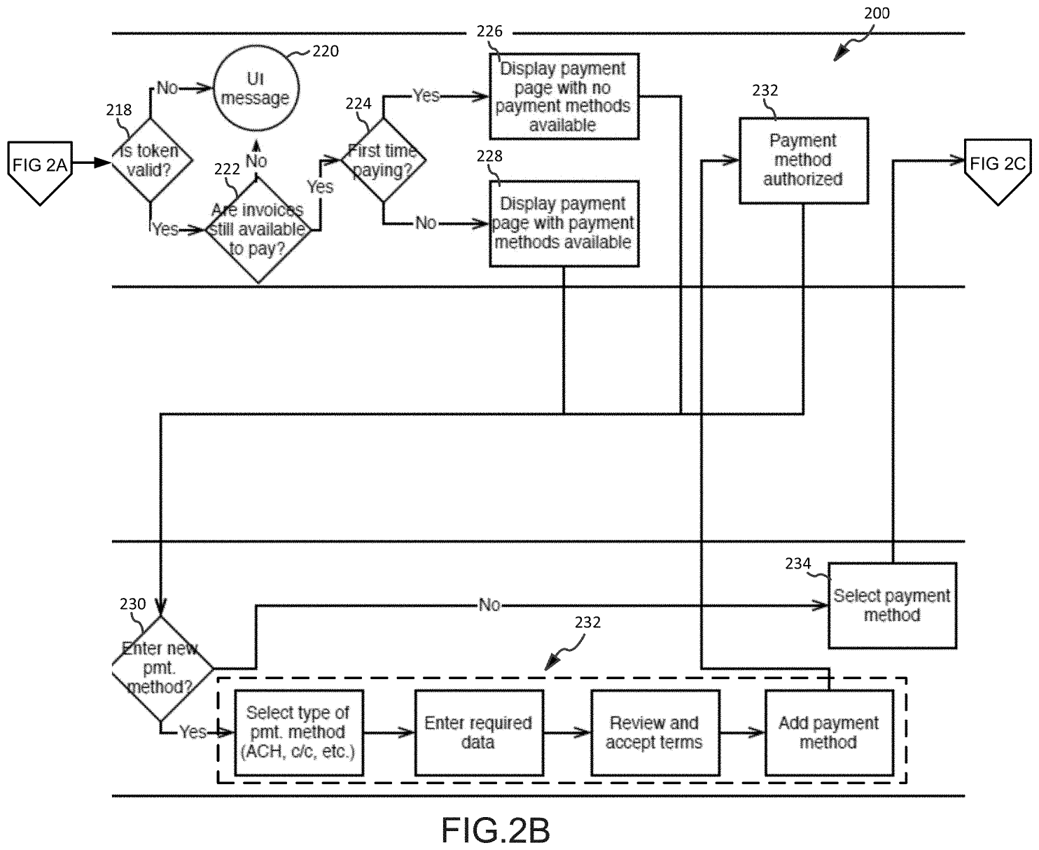

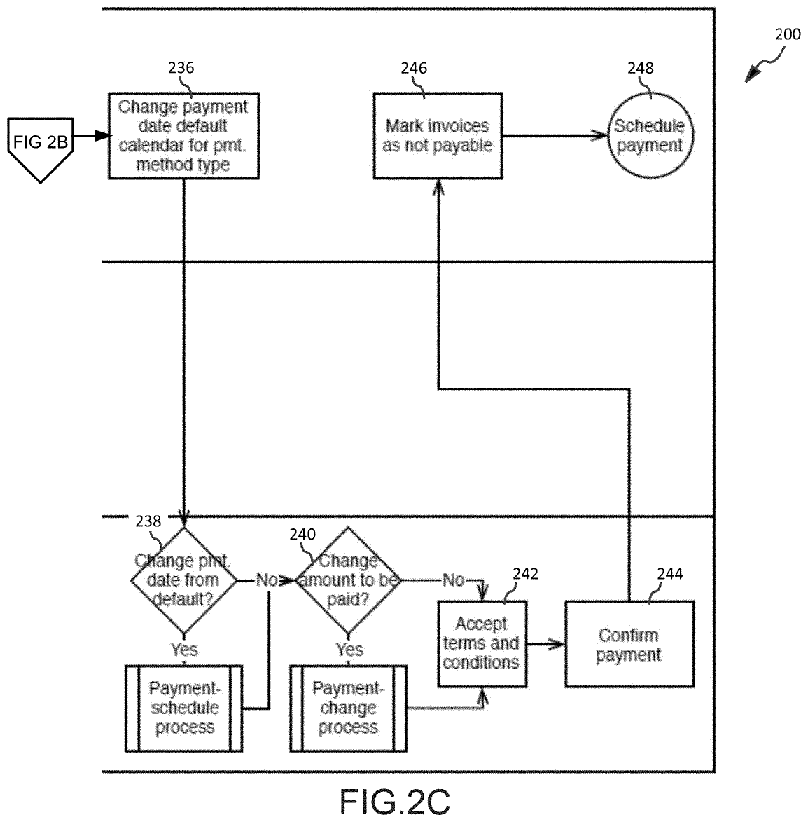

FIG. 2A illustrates a payment event process in a system for persistent on demand payments, in accordance with various embodiments;

FIG. 2B illustrates a payment event process in a system for persistent on demand payments, in accordance with various embodiments;

FIG. 2C illustrates a payment event process in a system for persistent on demand payments, in accordance with various embodiments;

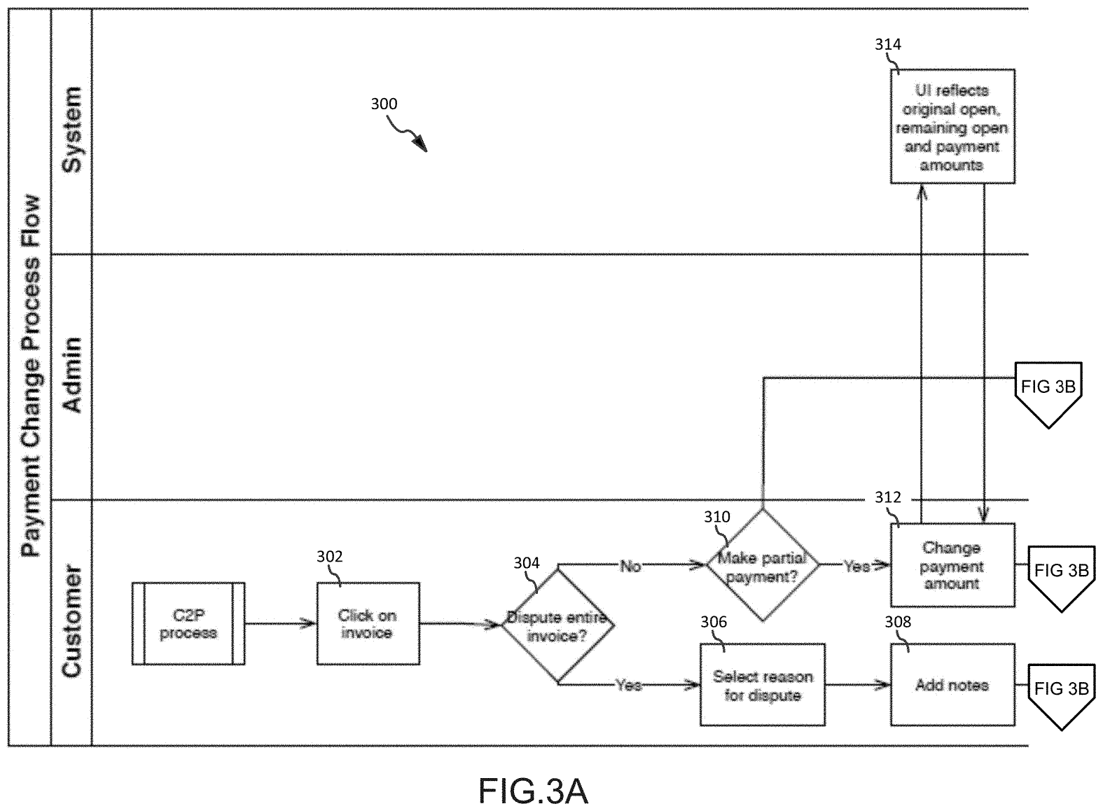

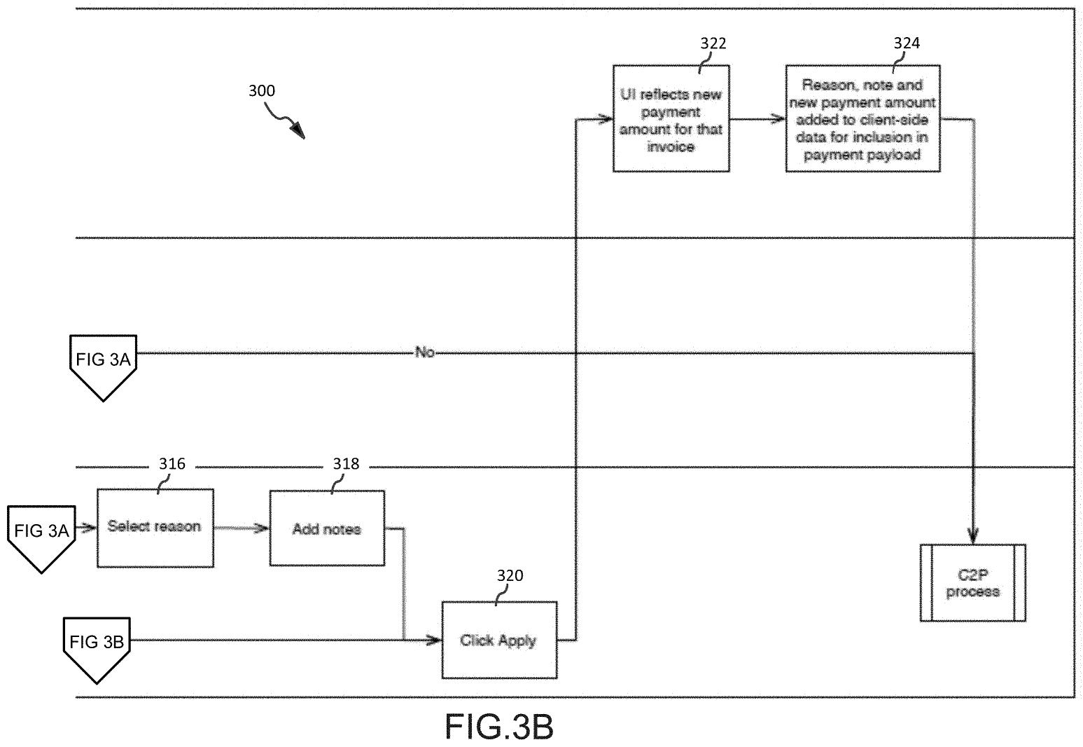

FIG. 3A illustrates a payment change process in a system for persistent on demand payments, in accordance with various embodiments;

FIG. 3B illustrates a payment change process in a system for persistent on demand payments, in accordance with various embodiments;

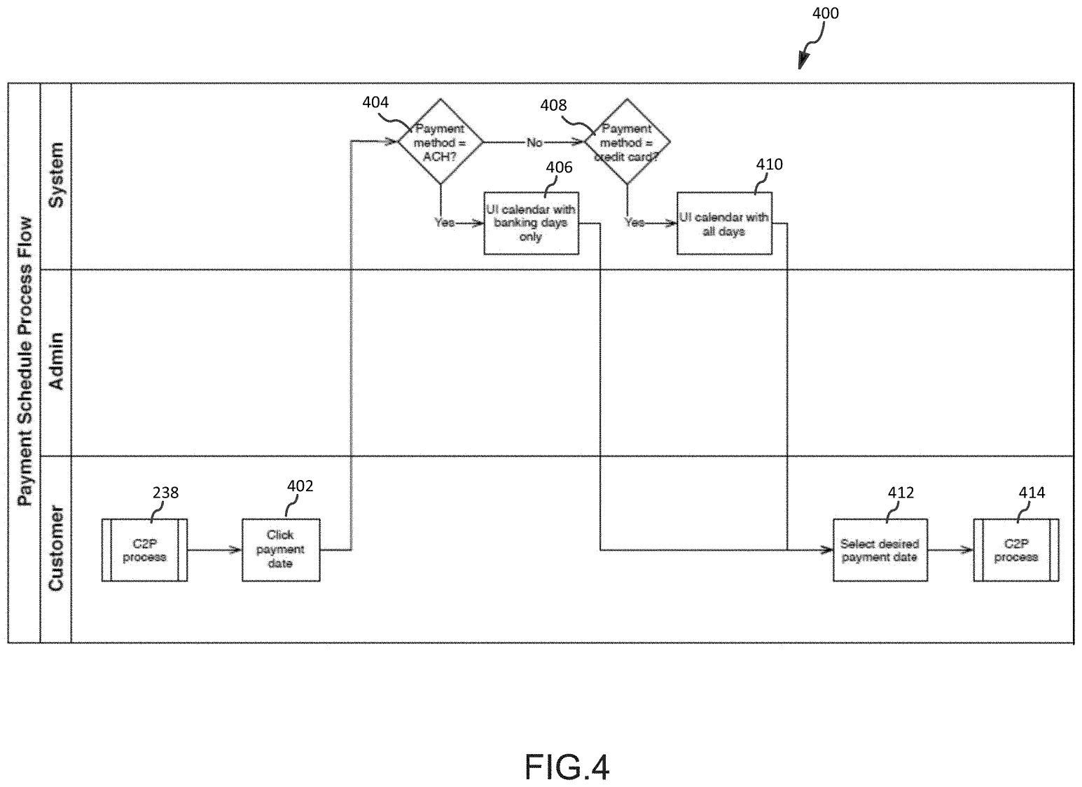

FIG. 4 illustrates a payment schedule process in a system for persistent on demand payments, in accordance with various embodiments;

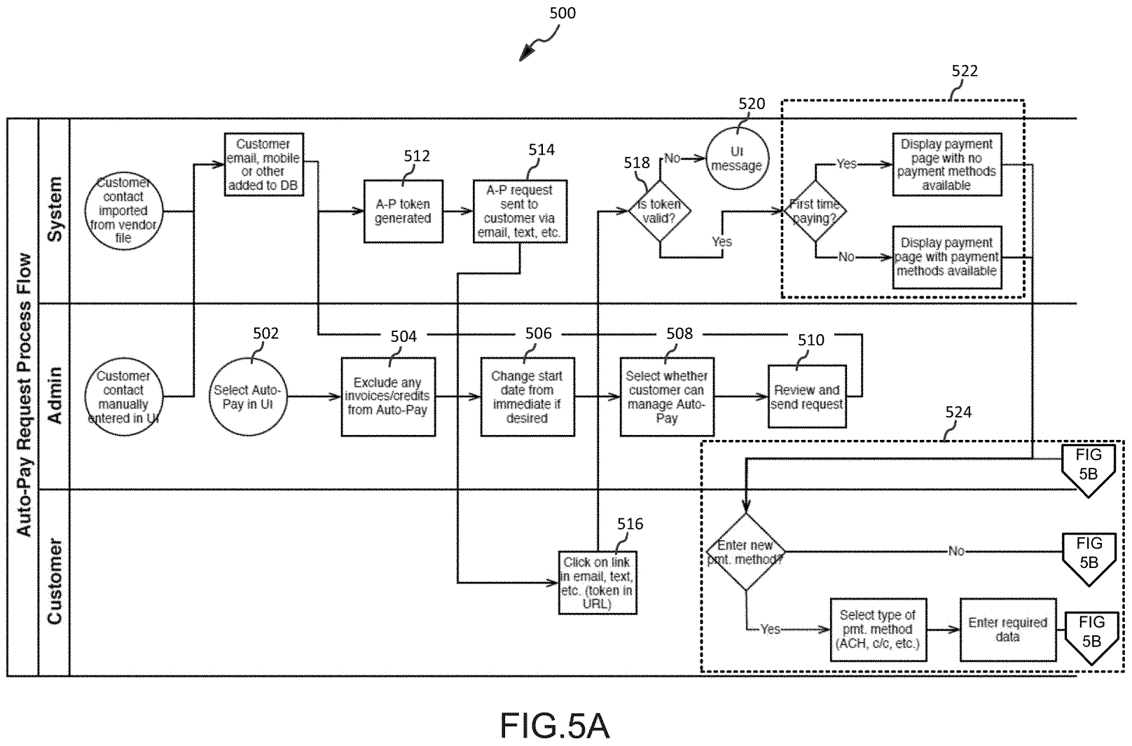

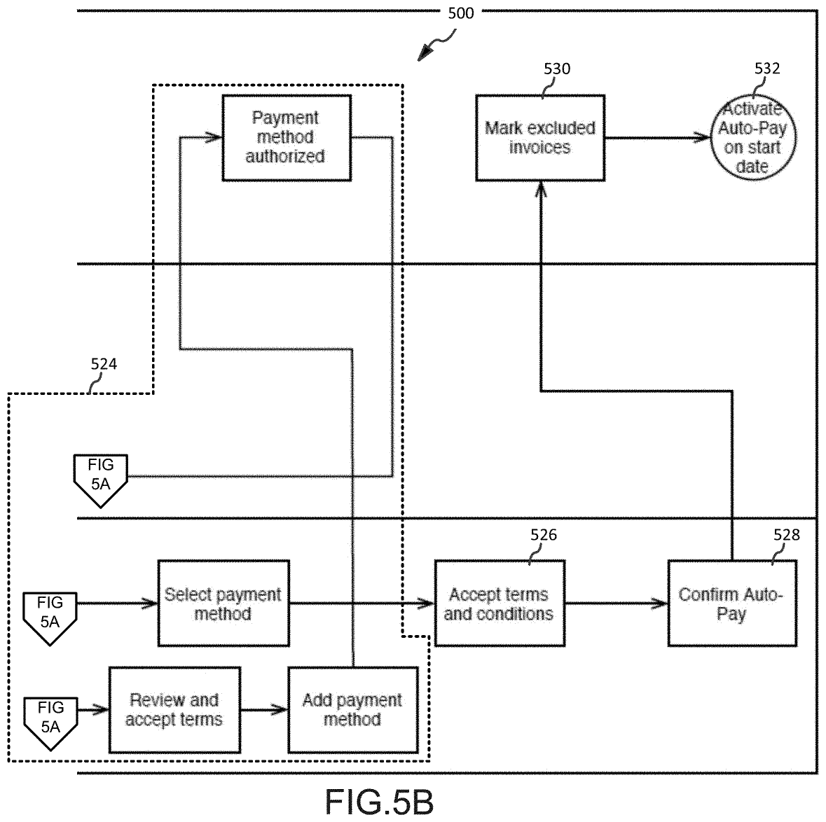

FIG. 5A illustrates an autopayment request process in a system for persistent on demand payments, in accordance with various embodiments;

FIG. 5B illustrates an autopayment request process in a system for persistent on demand payments, in accordance with various embodiments;

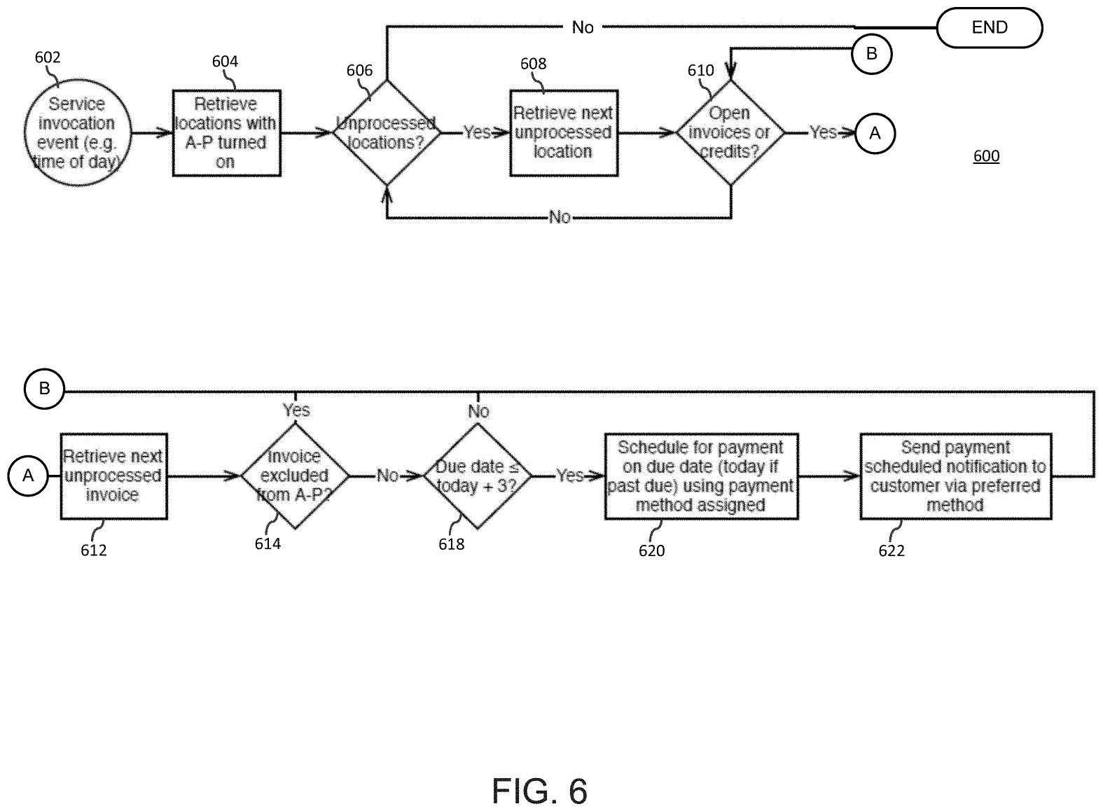

FIG. 6 illustrates an autopayment enabled payment event process in a system for persistent on demand payments, in accordance with various embodiments;

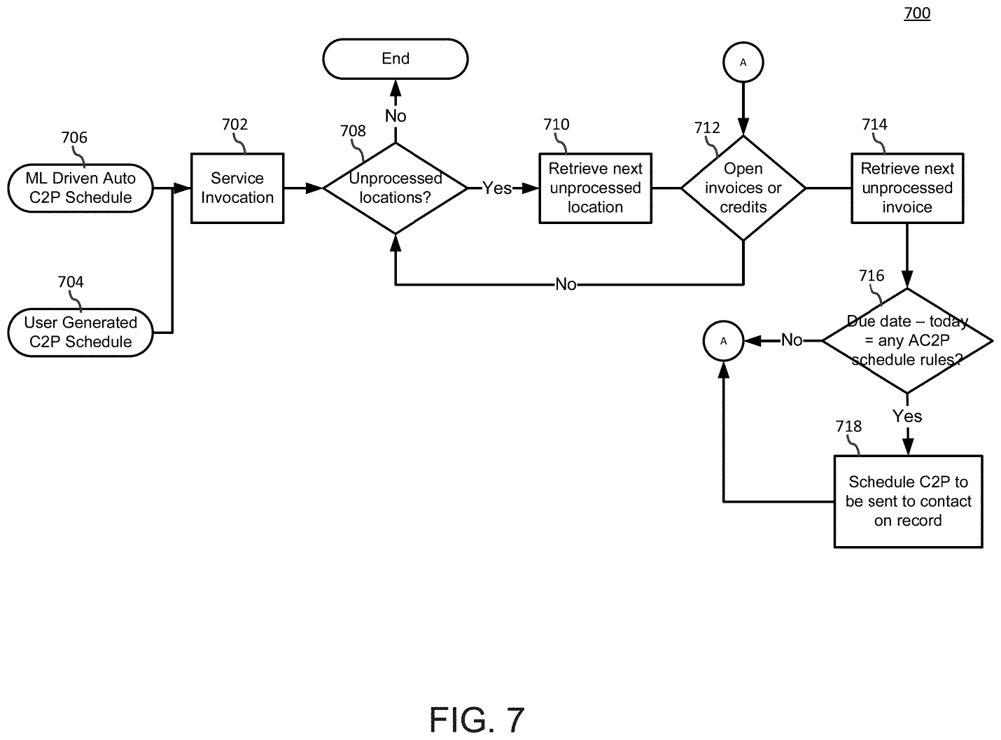

FIG. 7 illustrates a machine learning enabled payment event process in a system for persistent on demand payments, in accordance with various embodiments;

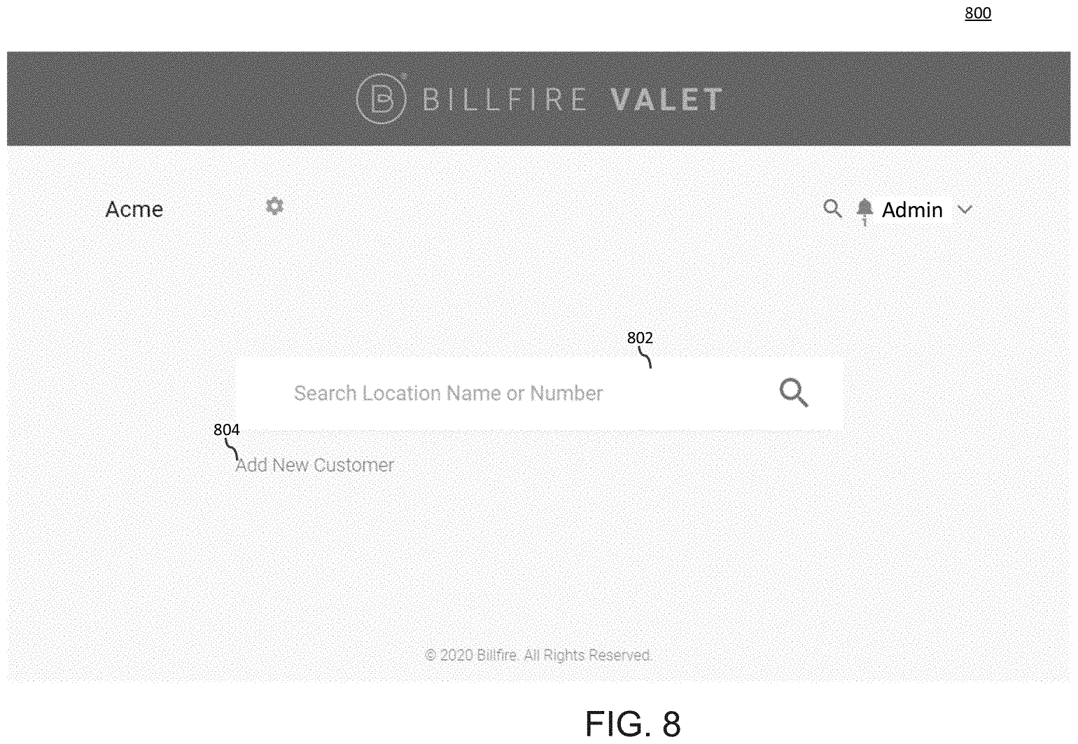

FIG. 8 illustrates an administrator portal in a system for persistent on demand payments, in accordance with various embodiments;

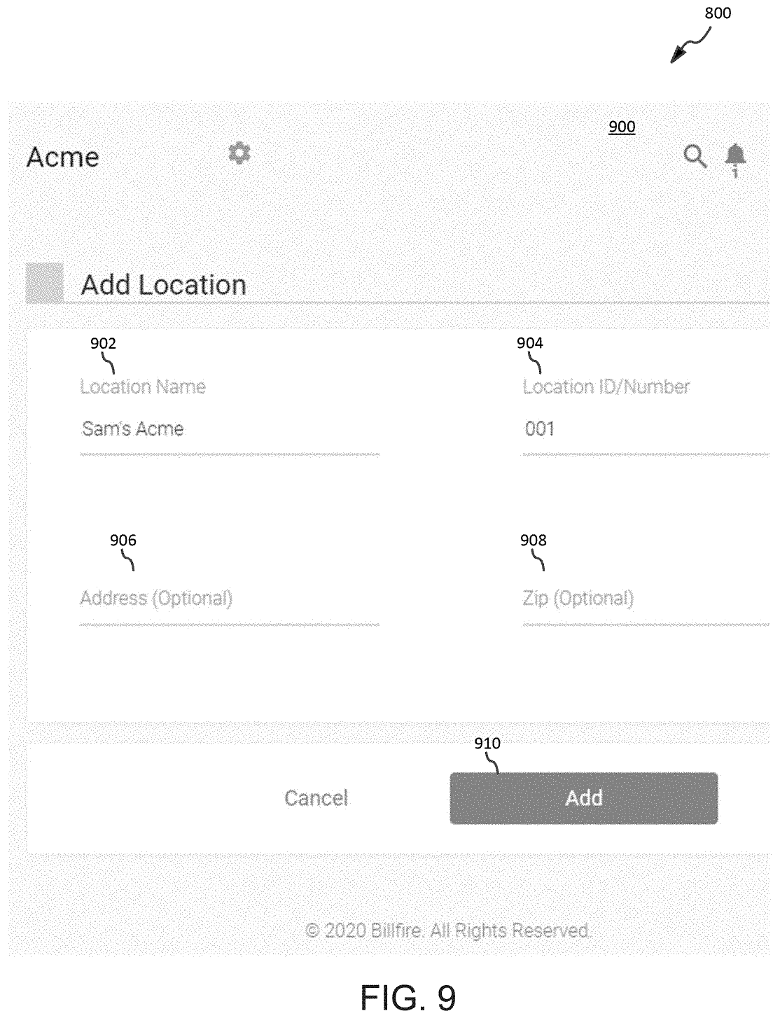

FIG. 9 illustrates an add location page in a system for persistent on demand payments, in accordance with various embodiments;

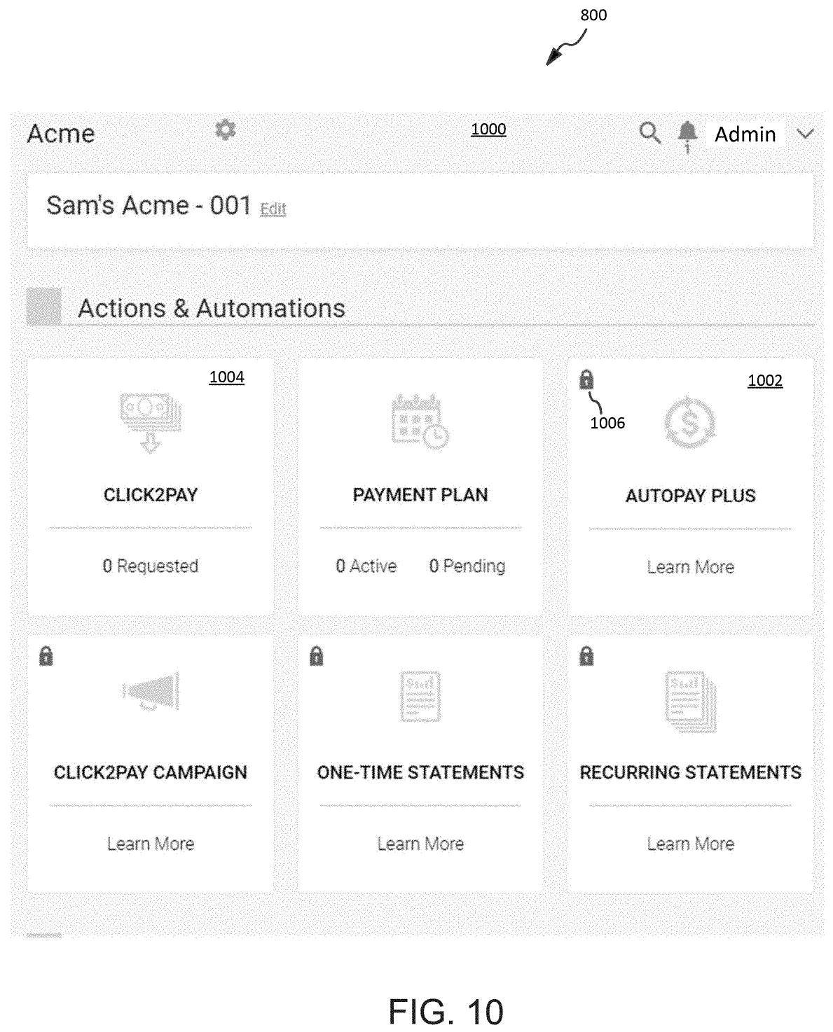

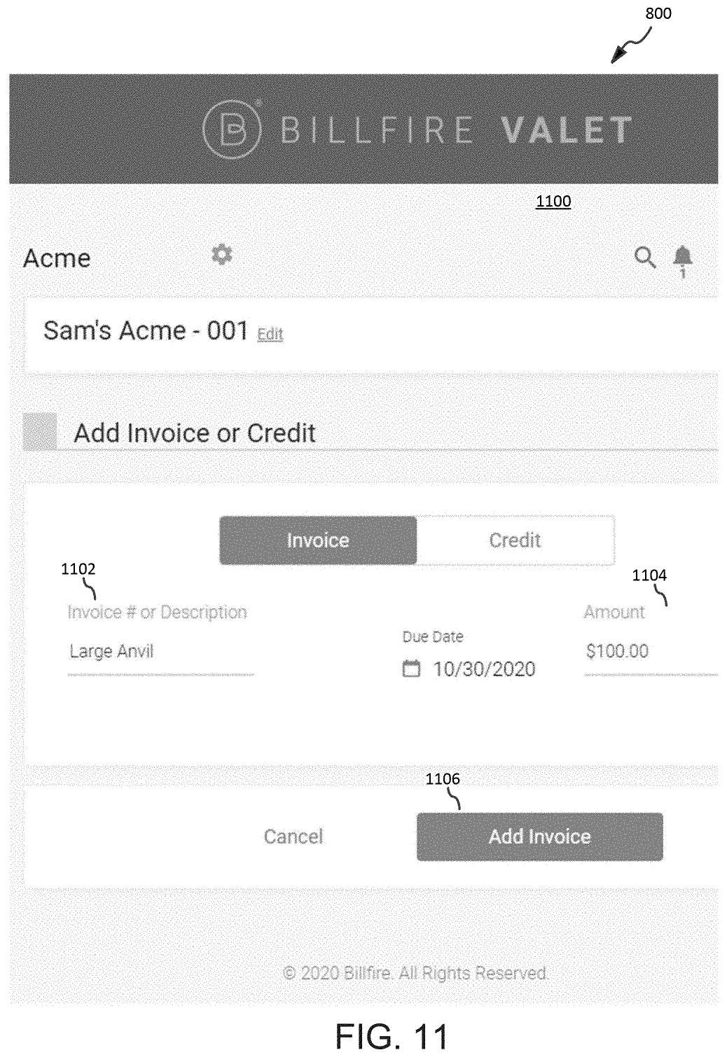

FIG. 10 illustrates an actions and automations page in a system for persistent on demand payments, in accordance with various embodiments;

FIG. 11 illustrates an add invoice or credit page in a system for persistent on demand payments, in accordance with various embodiments;

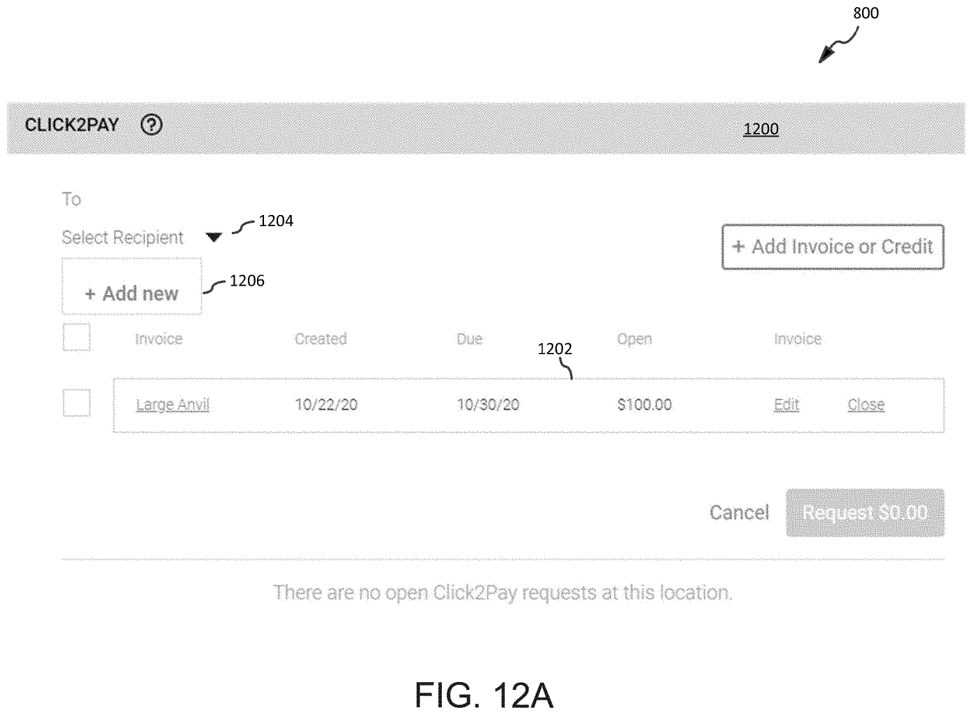

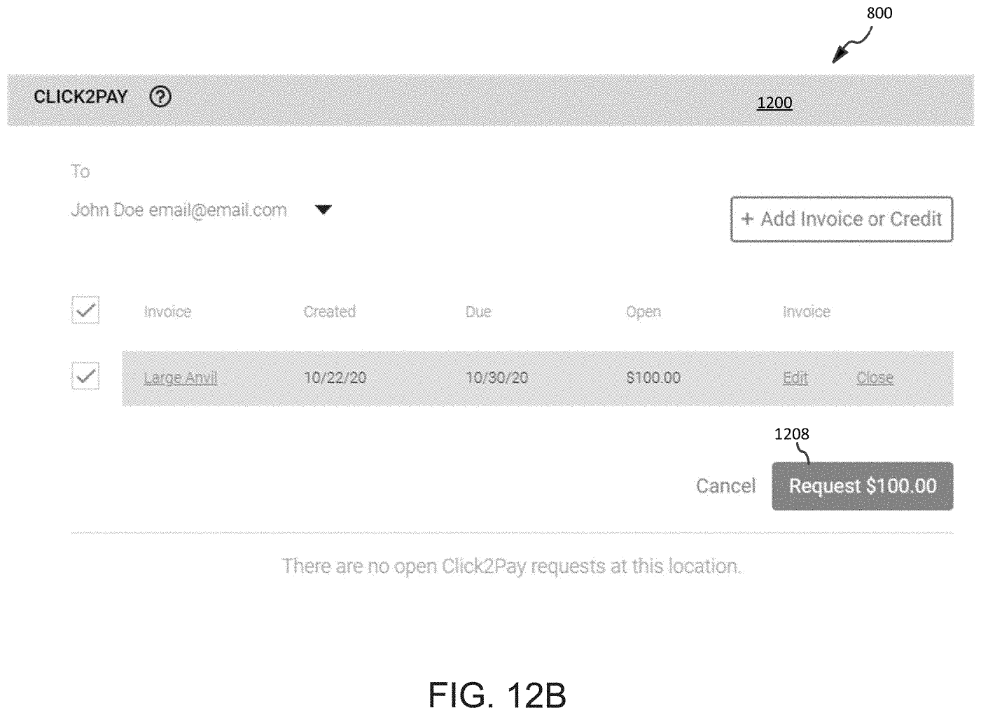

FIG. 12A illustrates a payment event process page in a system for persistent on demand payments, in accordance with various embodiments; and

FIG. 12B illustrates a payment event process page in a system for persistent on demand payments, in accordance with various embodiments.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

The system may provide a greater level of sophistication and/or control for invoicing and payments system. For example, invoicing and payments may tend to be highly regimented semi-automated and/or manual processes. In this regard, customization of traditional invoicing, payments processing, and/or the like based on payer specific variables may tend to be time consuming or inefficient with regard to computational resources. While prior art systems implement push architecture and typically demand single channel and/or set schedule payments, the current system may incorporate payer specific variables enabling invoicing and payment events to be generated on demand and tailored to individual payer preferences. For example, payment events may be generated based on payer metadata collected by the system and may implement a pull architecture for generating payment events.

As such, the system may eliminate or reduce missed payments, improve payment time, along with enabling enhanced automation features. In this regard, the system may also reduce the cost of development or system processing time for invoicing and payments, reduce network utilization, and/or reduce data storage overhead. The system may increase data reliability or accuracy by enabling standardization payer and payments metadata. The system may also reduce redundant payment and invoice requests, thereby reducing a demand for system resources. The system may simplify data mining and enhance user experience by enabling immediate dispute and feedback. Benefits of the present disclosure may apply to any suitable payment environment. For example, the present disclosure may apply in financial reporting contexts, payment services, as well as in information requests or fraud prevention contexts.

This process improves the functioning of the computer. For example, standardizing payment events and dispute reporting increases processing efficiency. Similarly, the process increases the reliability and speed of data presentation by enabling metadata capture and error reporting. In various embodiments, a payer specific payments process model is enabled that increases the reliability and speed of payments. Payers may select from a set of payer specific variables to customize payments and initiate disputes. In this regard, by transmitting, storing, and/or accessing data using the processes described herein, the quality of the data is improved and errors are reduced. Such improvements also increase the efficiency of the network by accelerating receipt of payments, reducing the portion of duplicated processes, and reducing redundant payment requests. In various embodiments, linking and storing payments based on standardized metadata sets significantly reduce back end processing and reduce troubleshooting for component processes. In various embodiments, the processes may increase network availability by reducing front end and back end process calls. In this regard, the processes may save processing resources including CPU time, memory resources, and/or network resources.

As used herein, “electronic communication” means communication of at least a portion of the electronic signals with physical coupling (e.g., “electrical communication” or “electrically coupled”) and/or without physical coupling and via an electromagnetic field (e.g., “inductive communication” or “inductively coupled” or “inductive coupling”). As used herein, “transmit” may include sending at least a portion of the electronic data from one system component to another (e.g., over a network connection). Additionally, as used herein, “data,” “information,” or the like may include encompassing information such as commands, queries, files, messages, data for storage, and the like in digital or any other form.

As used herein, “satisfy,” “meet,” “match,” “associated with”, or similar phrases may include an identical match, a partial match, meeting certain criteria, matching a subset of data, a correlation, satisfying certain criteria, a correspondence, an association, an algorithmic relationship, and/or the like. Similarly, as used herein, “authenticate” or similar terms may include an exact authentication, a partial authentication, authenticating a subset of data, a correspondence, satisfying certain criteria, an association, an algorithmic relationship, and/or the like.

Systems, methods, and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

With reference to FIG. 1, a system 100 for persistent on demand payments is depicted according to various embodiments. System 100 may include various computing devices, software modules, networks, and data structures in communication with one another. System 100 may also contemplate uses in association with web services, utility computing, pervasive and individualized computing, security and identity solutions, autonomic computing, cloud computing, commodity computing, mobility and wireless solutions, open source, biometrics, grid computing and/or mesh computing.

In various embodiments, system 100 may comprise a service provider system 102 (i.e., service provider), a user device 104, a data handler 106, a click-to-pay (C2P) event handler 108, a token generator 110, a transaction module 112, an administration module 114, and a database module 116 (i.e., a database). Any of these components may be outsourced and/or be in communication with service provider 102 via a network. System 100 may be computer based, and may comprise a processor, a tangible non-transitory computer-readable memory, and/or a network interface, along with other suitable system software and hardware components. Instructions stored on the tangible non-transitory memory may allow system 100 to perform various functions, as described herein. In various embodiments, service provider 102 may be configured as a central network element or hub to access various systems, engines, and components of system 100. Service provider 102 may comprise a network, computer-based system, and/or software components configured to provide an access point to various systems, engines, and components. Service provider 102 may be in operative and/or electronic communication with the user device 104, the data handler 106, the C2P event handler 108, the token generator 110, the transaction module 112, the administration module 114, and the database module 116. In this regard, the service provider 102 may allow communication from user device 104 and database module 116 to systems, engines, and components of system 100.

In various embodiments, user device 104 may comprise software and/or hardware in communication with the service provider 102 via a network comprising hardware and/or software configured to allow a payment account owner, an administrator, a user, a customer, and/or the like, access service provider 102. User device 104 may comprise any suitable device that is configured to allow a user to communicate with a network and service provider 102. User device 104 may include, for example, a personal computer, personal digital assistant, cellular phone, kiosk, a mobile device, and/or the like and may allow a user to transmit voice communications and/or data.

In various embodiments, database module 116 may include any number of data structures or data elements such as customer data 118, event data 120, invoice data 122, and event metadata 124. Database module 116 may be configured to maintain customer data 118 such as, for example, data relating to a customer (e.g., customer data records) such a card member name and address, a card member identifier, a card member vintage, a card member account identifier, a bank account number, a routing number, a username, an associated merchants list, a legal entity data, a transaction identifier, a device profile, a phone number, and/or the like. Database module 116 may be configured to maintain event data 120 such as, for example, a payment channel data, a dispute data, a payment event settings data, a payable date, a payment channel, a partial payment amount, a reminder date, a transaction data, and/or the like. Database module 116 may be configured to maintain invoice data 122 such as, for example, an invoice amount, an invoice date, a payable date, a payable amount, a phone number, a legal entity data, a username, a merchant name, an address, and/or the like. Database module 116 may be configured to maintain event metadata 124 such as, for example, data about the event data 120, a date, a time, a process outcome data and/or status data, an event action data, and/or the like. Event metadata 124 may include, for example, a lookup table of process actions indexed to a date and a time as illustrated in Table 1 below.

TABLE 1
Exemplary Payment Event Metadata

| Date | Time | | Action |
|---|---|---|---|
| Nov. 14, 2019 | 10:46 | AM | Payment scheduled by 555-555-5555 |
| Nov. 14, 2019 | 10:45 | AM | Click2Pay viewed by 555-555-5555 |
| Nov. 14, 2019 | 7:00 | AM | Invoice detail received |
| Nov. 14, 2019 | 5:00 | AM | Invoice updated from data feed |
| Nov. 12, 2019 | 2:47 | PM | Auto-Click2Pay disputed by |
| | | | jsmith@bennysburger.com |
| Nov. 12, 2019 | 2:45 | PM | Auto-Click2Pay viewed by |
| | | | jsmith@bennysburger.com |
| Nov. 12, 2019 | 11:25 | AM | Invoice detail viewed by 555-555-5555 |
| Nov. 12, 2019 | 11:23 | AM | Click2Pay viewed by 555-555-5555 |
| Nov. 12, 2019 | 10:47 | AM | Click2Pay received by 555-555-5555 |
| Nov. 12, 2019 | 10:45 | AM | Bob Jenkins sent Click2Pay to |
| | | | Joe Smith - 555-555-5555 |
| Nov. 11, 2019 | 12:01 | PM | Auto-Click2Pay received by |
| | | | jsmith@bennysburger.com |
| Nov. 11, 2019 | 12:00 | PM | Auto-Click2Pay sent to Joe Smith - |
| | | | jsmith@bennysburger.com |
| Nov. 11, 2019 | 7:00 | AM | Invoice detail received |
| Nov. 11, 2019 | 5:00 | AM | Open amount changed from data feed |
| Nov. 10, 2019 | 7:00 | AM | Invoice detail received |
| Nov. 10, 2019 | 5:00 | AM | Invoice created from data feed |

In various embodiments, the administration module 114 may include a GUI interface to the various systems, modules, and engines of system 100. Administration module 114 may be in operative and/or electronic communication with user device 104, the data handler 106, the C2P event handler 108, the token generator 110, the transaction module 112, and the database module 116. In this regard, administration module 114 may allow communication from user device 104 to systems, engines, and components of system 100.

In various embodiments, the transaction module 112 may comprise hardware or software configured to process transactions. The transaction module 112 may comprise or interact with a traditional payment network to facilitate purchases and payments, authorize transactions, and/or settle transactions. For example, transaction module 112 may interact existing proprietary networks that presently accommodate transactions for credit cards, debit cards, wire transfers, and/or other types of transaction accounts or transaction instruments. Transaction module 112 may comprise a portion of or may be configured to interface with a closed network that is secure from eavesdroppers. The transaction module 112 may be configured to execute transactions via an exemplary transaction network such as AMERICAN EXPRESS®, VISANET®, MASTERCARD®, DISCOVER®, INTERAC®, Cartes Bancaires, JCB®, private networks (e.g., merchant networks), automated clearing house (ACH), and/or any other payment network.

In various embodiments, the data handler 106 may be configured to receive data such as, for example, invoice data and customer data from a merchant. In various embodiments, the data handler 106 may be configured to generate event metadata 124 such as, for example, payment event metadata. In various embodiments, data handler 106 may comprise machine learning algorithms configured to evaluate the payment event metadata, a payment event settings data, the customer data, and the invoice data to determine a targeted payment event. For example, the system may determine based on analysis of payment channel metadata associated with a user that the user prefers a particular communication channel. The system may further determine based on the payment event metadata such as, for example, a time of payment, that payments are received in a particular time window. The system may then generate the targeted payment event for transmittal via the particular communication channel at the particular time window. In this regard a customizable payment event may be rendered by the system as a targeted payment event.

In various embodiments, the C2P event handler 108 may comprise a configurable rule set defining a customizable payment event. The C2P event handler 108 may create the customizable payment event based on the invoice data 122, the event data 120, and the customer data 118. The C2P event handler 108 may request an event token from the token generator 110. The C2P event handler 108 may associate the event token with the customizable payment event. In this regard, the event token may be linked to the customizable payment event. In various embodiments, the C2P event handler 108 may be configured to transmit the event token to the user device 104. In various embodiments, the C2P event handler 108 may be configured to update the customizable payment event based on data received from the user device 104. For example, the C2P event handler 108 may update the customizable payment event based on receiving payment channel data such as for example, ACH account/routing numbers, a credit card number, a checking account number, and or the like.

In another example, the C2P event handler 108 may update the customizable payment event based on receiving dispute data. In various embodiments, the dispute data may comprise text based input, a dispute type, a dispute category, a value and/or the like to define a standard set of disputes. The dispute data may define disputes such as, “missing goods”, “damaged goods”, “late arrival”, “spoilage”, “undelivered”, “insufficient quantity”, “non-conforming goods”, and/or the like. In this regard, the dispute process of a customizable payment event may be a multi-threaded or two-way process. Communications via the dispute process may be tracked by the system and presented to system users or administrators. In this regard, the system may provide enhanced transparency by providing a record of system inputs, outputs, and other communications presented in a chronological order.

Referring now to FIGS. 2A-7, the process flows depicted are merely embodiments and are not intended to limit the scope of the disclosure. For example, the steps recited in any of the method or process descriptions may be executed in any order and are not limited to the order presented. It will be appreciated that the following description makes appropriate references not only to the steps depicted in FIGS. 2A-7, but also to the various system components as described above with reference to FIG. 1.

In various embodiments, and with reference to FIGS. 2A, 2B, and 2C a payment event process 200 of system 100 is illustrated. The system may receive data via the data handler 106 (step 202). For example, the data handler 106 may import customer contact information, invoice data, or other data included, for example, in big data sets such as a merchant data set, a payment network data set, a government records data set and/or the like. The system may receive data via the administration module 114 (step 204). The data may include customer contact information such as a mobile phone number, an email address, a username, and/or the like. The system may store the received data (step 206). For example, the customer contact data may be stored as customer data 118 in the database module 116. The system may generate the customizable payment event (step 208). In various embodiments, the customizable payment event may be generated in response to one or more event generation conditions which may be defined by user configurable payment event settings. In various embodiments, the customizable payment event may be generated in response to receiving a request to generate the customizable payment event (step 210). For example, the system may receive the request to generate the customizable payment event from the user device 104 via the administration module 114.

The system may generate an event token (e.g., a first event token) associated on a one-to-one basis with the customizable payment event (step 212). In this regard, the event token is linked to the customizable payment event and may be stored as event data 120 in database module 116. The system may transmit the event token to the user device 104 (step 214). For example, the system may select a communications channel based on the customer data 118 and transmit the event token via the communications channel. Step 214 includes transmitting the event token across multiple channels simultaneously such as, for example, email, short message service (SMS), rich communications service (RCS), or any other suitable communications channel.

The system may receive an event token access message from the user device 104 (step 216). In various embodiments, step 216 may include receiving the event token from the user device 104. In various embodiments, step 216 may include receiving device profile or device fingerprint information from the user device 104. The system may determine the validity of the event token in response to the token access message (step 218). In various embodiments, the system may provide further communications related to the customizable payment event via the communication channel associated with the token access message. For example, if a first token is accessed via an SMS communication channel the system may provide further messages associated with the first token via the SMS communication channel. In another example, if a second token is accessed via an email communication channel the system may provide further messages associated with the second token via the email communication channel. In various embodiments, the system may maintain communications threads which are threaded by each customizable payment event and associated with the communication channel of the token access message. In this regard, if the fi In response to determining an invalid event token, the system may display an error message (step 220). In response to determine a valid event token, the system may determine a payable invoice (step 222). For example, the system may compare the invoice data 122, the event data 120 and the customer data 118 to find unpaid invoices associated with customer contact information such as, for example, a phone number or an email address and not associated with a customizable payment event. Step 222 may include setting, by the system, an available to be paid flag of the invoice data. In various embodiments, step 222 may include checking for an ‘excluded’ flag of the invoice data. In response to determining no payable invoice, the system may proceed to step 220.

In various embodiments, the system may generate and transmit event tokens based on a payment schedule process and/or a customizable rule set for event token transmission. For example, the system may transmit a first event token via a first communications channel and a second event token via a second communications channel. In another example, the system may transmit the second event token in response to determining the first event token is invalid. In another example, the system may transmit the second event token in response to an elapsed time threshold. As another example, multiple event tokens may be sent to multiple users via multiple communication methods, simultaneously, as the system will prevent duplicate payments automatically.

In various embodiments and in response to determining a payable invoice, the system search for payment events associated with the customer data to determine a first time payment status (step 224). For example, the system may search and compare the event data 120, the event metadata 124, the invoice data, and the customer data 118 for associated payment channel data. In response to determining the first time payment status, the system may display a payment page with no payment methods available for selection (step 226). Otherwise, the system may display the payment page with selectable payment methods populated based on the associated payment channel data (step 228). In various embodiments, the system generates a prompt for new payment methods (step 230). The system may receive a new payment method request in response to the new payment methods prompt and start a new payment method process (step 232). In various embodiments, step 232 may include receiving a payment channel (e.g., ACH, credit card, debit card, etc.) selection, receiving payment channel data, presenting terms and conditions, and receiving an acceptance message. Step 232 may include associating the payment channel data with the customer data 118 in the database module 116. Step 232 may include validating or authorizing the payment channel data by the transaction module 112. The system may receive payment channel data including a selected payment method (step 234).

In response to receiving the payment method selection, the system may display a user configurable payment event settings interface (step 236). The system may be configured to receive payment event settings data via the user configurable payment event settings interface. In response to receiving the payment event settings data, the system may update the customizable payment event based on the payment event settings data. In various embodiments, the payment event settings data may include, for example, a payment date change request, a new payment date, a payment change request, a new payment amount, a new payment type, and/or the like. In various embodiments, the system may start a payment schedule process in response to receiving the payment date change request (step 238). In various embodiments, the system may start a payment change process in response to receiving the payment change request (step 240). The system may display payment terms and conditions via the user device 104 and may receive an acceptance message in response (step 242). The system may display a payment confirmation message via the user device 104 (step 244). The system may update the invoice data 122 to indicate the payable invoice associated with the user configurable payment event as paid (e.g., partially paid, non-payable etc.) (step 246). Step 246 may include capturing event metadata 124, associating the paid invoice with the customer data 118, updating the ‘excluded’ flag, updating the ‘available to be paid’ flag, and/or other such database module 116 operations. In this regard, the system may enable a user to exclude open invoices from processor until processing is once again enabled. Similarly, the system may enable invoices to be excluded from payment processing by a business rules set which may be determined by the system (e.g., via a machine learning algorithm) or selected by an administration. Thereby, the system may tend to inhibit errors such as double payment of invoices (i.e., double payment events). The system may execute a payment transaction (i.e., via transaction module 112) based on the payment channel data and the payable invoice (step 248).

In various embodiments and with additional reference to FIGS. 3A and 3B, 2C a payment change process 300 of system 100 is illustrated. The system may display invoice data 122 (step 302). The displayed invoice data may include, for example, a payable invoice or a paid invoice associated with the customer data 118. In various embodiments, step 302 includes receiving an invoice selection defining a selected invoice of the displayed invoice data 122. The system may prompt via user device 104 for a dispute request (step 304). The system may display a set of dispute options and, in response, receive dispute data comprising one or more elements associated with the dispute options display (step 306). In various embodiments, the system may receive plain text input related to the dispute request (step 308).

In various embodiments, the system may prompt via user device 104 for a partial payment request (step 310). The system may receive a new payment amount (step 312). The system may calculate an open balance of a payable invoice amount and display the open balance via the user device 104 (step 314). The system may display a set of payment change options and, in response, receive payment change data comprising one or more elements associated with the payment change options display (step 316). In various embodiments, the system may receive plain text input related to the payment change request (step 318). In various embodiments, the system may prompt for a change approval via the user device 104 and receive a change approval message (step 320). In response to the change approval message the system may update the customizable payment event (step 322). In various embodiments, step 322 may include capturing event metadata 124. The system may associate the dispute data, the payment change data, and the event metadata 124 in the database module 116 (step 324).

In various embodiments and with additional reference to FIG. 4 a payment schedule process 400 of system 100 is illustrated. The system may receive the payment date change request (step 402). Step 402 may include displaying an interactive default payment date via the user device 104. The system may determine a time gated payment method (step 404). In various embodiments, the system may evaluate the event data and/or related payment channel data to determine the time gated payment method. For example, the system may find an ACH payment channel is selected as the payment method. The system may display an interactive calendar and apply a time gated payment method rule based on the time gated payment method (step 406). For example, the ACH payment channel may only be active on banking days such as weekdays. In response, the system may display a calendar comprising only banking days such as weekdays. The system may determine a non-time gated payment method (step 408). In response to determining the non-time gated payment method, the system may display the interactive calendar without applying the time gated payment method rule (step 410). The system may receive a new payment date (step 416). For example, the system may receive the new payment date form the user device 104 based on a user interaction with the interactive calendar such as, for example, clicking the desired date. The system may schedule a payment transaction for execution on the new payment date (step 414). In this regard, step 414 may include updating the customizable payment event with the new payment date in place of a default payment date, such as the payable invoice due date.

In various embodiments and with additional reference to FIGS. 5A and 5B an autopayment enrollment request process 500 of system 100 is illustrated. The system may receive an enrollment initiation request (step 502). For example, step 502 may include selecting via the user device 104 an autopayment settings page of the administration module 114 to generate autopayment enrollment data. The system may prompt for excluded payment events (step 504). For example, the system may display one or more elements of invoice data 122 such as payable invoices, partially paid invoices, credits, and/or the like which may be selected via user device 104 for exclusion from the autopayment process. The system may receive an autopayment start date (step 506). The system may receive an autopayment permissions selection (step 508). In various embodiments, the autopayment permissions selection may define whether a customizable payment event associated with the autopayment process may be altered by one or more classes of system 100 users. In various embodiments, the autopayment permissions selection may inhibit system 100 from starting the payment change process and/or the payment schedule process.

The system may present autopayment enrollment data based on the inputs received in steps 504-508 for review (step 510). The system may generate an autopayment event token (e.g., a second event token) based on the autopayment enrollment data (step 512). The system may transmit the second event token via a communication channel to the user device 104 (step 514). In various embodiments, the communication channel may be selected based on a communications selection rule set which may be configured via administration module 114. The system may receive an event token access message from the user device 104 comprising an autopayment enrollment confirmation (step 516). The system may determine the validity of the event token in response to the token access message and the autopayment enrollment confirmation (step 518). In response to determining an invalid event token, the system may display an error message (step 520). The system may start a payment display selection process in response to determining a valid event token (step 522). In various embodiments, the payment display selection process may, for example, be similar to that described in steps 224-228 of FIG. 2B. In various embodiments, step 522 may include receiving a payment channel selection.

The system may start a payment authorization and new payment method process (step 524). The payment authorization and new payment method process may, for example, be similar to that described in steps 230-234 of FIG. 2B. In various embodiments, the system may display via user device 104 an interactive terms and conditions related to the autopayment process (step 526). The system may receive an autopayment confirmation message from the user device 104 (step 528). In response, the system may update the invoice data 122 to mark one or more payable invoices associated with the user configurable payment event for processing via the autopayment process (step 530). Step 530 may include capturing event metadata 124, associating the paid invoice with the customer data 118, and/or other such database module 116 operations. The system may schedule an autopayment enabled payment event process to start autopayment enrollment data (step 532). For example, the autopayment event process may be scheduled to start at the autopayment start date.

In various embodiments and with additional reference to FIG. 6, an autopayment enabled payment event process 600 of system 100 is illustrated. The system may start the process 600 in response to a rule based invocation condition (step 602). For example, the system may start the process when the current date equals the autopayment start date, or in response to an elapsed time counter, or in response to a user initiated start request, and/or other suitable condition. The system may retrieve autopayment associated invoice data 122 and/or event data 120 from the database module 116 (step 604). For example, the system may retrieve the user configurable payment events for processing via the autopayment process associated via process 500. The system may evaluate the retrieved data to determine a first unprocessed location (step 606). Otherwise, the process may halt. In response to determining the first unprocessed location, the system may retrieve a next unprocessed location (step 608). The system may determine whether any open invoices are available for processing and/or whether any outstanding credits may be applied (step 610). Step 610 may include checking the ‘available to be paid’ flag and the ‘excluded’ flag to determine the open invoice. The process may otherwise return to step 606. The system may retrieve the next unprocessed invoice (step 612). The system may determine an invoice exclusion and, in response recycle to step 610 (step 614). For example, the system may evaluate the retrieved unprocessed invoices against the autopayment enrollment data to determine whether the retrieved invoices have been marked as excluded (e.g., via step 504 of process 500).

In various embodiments, the system may apply a scheduling rule (step 618). For example, where the payable invoice due date is within a threshold value of the current date the process may continue. In another example, the process may continue where the invoice due date is less than or equal to three days forward of the current date. Otherwise, the process may recycle to step 610. The system may schedule a payment transaction based on the invoice due date and the payment channel selection (step 620). For example, the payment transaction may be scheduled based on the autopayment enrollment data and the inputs of steps 522 and 524. Step 620 includes transaction module 112 executing a transaction associated with the invoices processed via steps 610-618 based on the payment channel data and the invoice due date. In various embodiments, the system may transmit a payment scheduled notification to the user device 104 in response to scheduling the payment transaction based on the invoice due date and the payment channel selection (step 622).

In various embodiments and with additional reference to FIG. 7, a machine learning enabled payment event process 700 of system 100 is illustrated. The system may start the process 700 in response to a start request (step 702). In various embodiments, the system may receive the start request from the user device 104 (step 704). In various embodiments, the start request may be generated by the system via a machine learning enabled event driver (step 706). The machine learning enabled event driver may apply a machine learning algorithm to the various data elements of database module 116. The machine learning algorithm may be tuned to optimize the time between transmission of the event token and execution of the payment transaction. In this regard, system 100 may develop a ML based rule set for customizable payment event creation, event token generation, event token transmission, and payment transaction execution. For example, for a given user, the event metadata may indicate event tokens are accessed more frequently via a first communication channel than a second communication channel. The event driver may invoke system 100 services and start processes to create the user configurable payment event, generate the associated event token, and transmit the event token via the first communication channel.

In various embodiments, the system may evaluate the database module 116 for unprocessed locations to determine a first unprocessed location (step 708) Otherwise, the process may halt. In various embodiments, step 708 includes retrieving invoice data 122 and/or event data 120 from the database module 116. For example, the system may retrieve the user configurable payment events for processing via process 200. In response to determining the first unprocessed location, the system may retrieve a next unprocessed location (step 710). The system may determine whether any open invoices are available for processing and/or whether any outstanding credits may be applied (step 712). Step 712 may include checking the ‘available to be paid’ flag and the ‘excluded’ flag to determine the open invoice. The process may otherwise return to step 708. The system may retrieve the next unprocessed invoice (step 714). The system may determine whether any rules of the ML based rule set or any user customized rules apply and, if not response recycle to step 712 (step 716). In various embodiments, the system may start process 200 based on the output of the applicable rule set (step 718). For example, the system may create a customizable payment event, generate an associated event token, and transmit the event token to the user device 104 in response to the applicable rule output.

In various embodiments and with additional reference to FIGS. 8-10, the system may employ a valet multi-factor authentication (MFA) method for authorizing payments. The valet MFA may enable seamless secure customer payments. The system may display an administrator portal 800 configured to receive a location search request via search field 802 and to generate a new location in response to an interaction with button 804. In response to selecting the button 804 the system may display an add location page 900 configured to receive various elements of location data such as, for example, a location name 902 (e.g., “Sam's Acme”), a location ID 904 (e.g., “001”), an address 906, and a zip code 908. The system may receive the location name 902 and the location ID 904 and generate the new location based on the location data and in response to an interaction with the add location button 910. In response to generating the new location, the system may display, via the administrator portal 800, an actions and automations page 1000 associated with the new location. The actions and automations page 1000 may enable command and control of various features and elements of the system. For example, the automations page 1000 may enable initialization of the autopayment process via button 1002 or the click2pay process via button 1004. In various embodiments, the system may determine, based on the location data, that certain processes are unavailable or may not be started. For example, the system may indicate via an icon 1006 that the autopayment process is unavailable to be applied to the location data associated with the “Sam's Acme” location name and the “001” location ID.

As shown with additional reference to FIG. 11, the system may display an add invoice or credit page 1100 of the administrator portal 800 in response to selecting the button 1004. The invoice or credit page 1100 may be configured to receive invoice data such as invoice description data 1102 such as, for example, an numerical identifier or textural input (e.g., “Large Anvil). The page 110 may be configured to receive an invoice amount 1104 (e.g., $100). In various embodiments, the system may generate a payable invoice for association with a customizable payment event in response to selecting the add invoice button 1106. With additional reference to FIG. 12A, the system may display a payment event process page 1200 in response to generating the payable invoice for association with the customizable payment event. Page 1200 may display one or more payable invoices for association 1202 with the customizable payment event. Page 1200 may be configured to receive a recipient for associate with the customizable payment event via, for example, dropdown menu 1204. In various embodiments, the system may enable generation of new recipients by prompting, e.g, via add new button 1206, for entry of recipient data (e.g., customer data 118). For example, in response to selecting the add new button 1206 the system may prompt for the entry of and be configured to receive a first name, a last name, and one or more communications channels associated with a recipient device (i.e., user devices) such as, for example, an email and a cell phone number. The system may receive the first name “John” and the last name “Doe” and may receive an email such as “email@email.com”. The system may associate each of the received communications channels with the recipient data. As shown with additional reference to FIG. 12B, the system may receive a communications channel selection and an invoice selection and may associate the selected communication channel and the selected invoice with the customizable payment event. In various embodiments and in response to selecting the request button 1208 the system may generate the customizable payment event and an event token associated therewith. The system may then transmit the event token to the user device 104 associated with the selected communication channel.

In various embodiments, the event token may be accessed via the user device 104. The event token may command the user device to connect with a customer access point, a customer portal, and/or the like of the system. For example, the system may command the user device 104 to open a web session tracked by the event token which may be configured to prompt for and receive payment channel data. In response to receiving the payment channel data, the system may associate on a one-to-one basis the payment channel data, the communication channel data, and the location data and may prompt for payment execution. The system may receive a payment execution command via the customer portal. The system may execute a payment transaction based on the invoice and the payment channel data. The system may store the associated payment channel data, communication channel data, and location data in database 116 as customer data 118. Thereby, the system may enable one-click payments in future customizable payment events. In this regard, the combination of having received the event token based on a communication channel received via the administrator portal and a payment channel received via a customer portal may provide authentication of payments. Stated another way, the system may authenticate a payment transaction based on first receiving, via an administrator portal, a communication channel, and second, receiving, via a customer access point, a payment channel data and/or the payment execution command. In this regard, the system may authenticate execute a subsequent transaction (i.e., a second transaction) based on the initially received payment channel data and a subsequent payment authorization received by the system via the selected communication channel associated with the payment channel.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Terms and phrases similar to “associate” and/or “associating” may include tagging, flagging, correlating, using a look-up table or any other method or system for indicating or creating a relationship between elements, such as, for example, (i) a transaction account and (ii) an item (e.g., offer, reward, discount) and/or digital channel. Moreover, the associating may occur at any point, in response to any suitable action, event, or period of time. The associating may occur at pre-determined intervals, periodically, randomly, once, more than once, or in response to a suitable request or action. Any of the information may be distributed and/or accessed via a software enabled link, wherein the link may be sent via an email, text, post, social network input, and/or any other method known in the art.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® operating system, an APPLE® iOS operating system, a BLACKBERRY® company's operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Adobe COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript, or the like.

The system and method are described herein with reference to screen shots, block diagrams and flowchart illustrations of methods, apparatus, and computer program products according to various embodiments. It will be understood that each functional block of the block diagrams and the flowchart illustrations, and combinations of functional blocks in the block diagrams and flowchart illustrations, respectively, can be implemented by computer program instructions

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS® applications, webpages, websites, web forms, prompts, etc. Practitioners will appreciate that the illustrated steps described herein may comprise, in any number of configurations, including the use of WINDOWS® applications, webpages, web forms, popup WINDOWS® applications, prompts, and the like. It should be further appreciated that the multiple steps as illustrated and described may be combined into single webpages and/or WINDOWS® applications but have been expanded for the sake of simplicity. In other cases, steps illustrated and described as single process steps may be separated into multiple webpages and/or WINDOWS® applications but have been combined for simplicity.

In various embodiments, the software elements of the system may also be implemented using a JAVASCRIPT® run-time environment configured to execute JAVASCRIPT® code outside of a web browser. For example, the software elements of the system may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager, such as, for example, Parallel Multithreaded Machine (“PM2”); a resource and performance monitoring tool, such as, for example, Node Application Metrics (“appmetrics”); a library module for building user interfaces, and/or any other suitable and/or desired module.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the internet server. Middleware may be configured to process transactions between the various components of an application server and any number of internal or external systems for any of the purposes disclosed herein. WEBSPHERE® MQ™ (formerly MQSeries) by IBM®, Inc. (Armonk, N.Y.) is an example of a commercially available middleware product. An Enterprise Service Bus (“ESB”) application is another example of middleware

The computers discussed herein may provide a suitable website or other internet-based graphical user interface which is accessible by users. In one embodiment, MICROSOFT® company's Internet Information Services (IIS), Transaction Server (MTS) service, and an SQL SERVER® database, are used in conjunction with MICROSOFT® operating systems, WINDOWS NT® web server software, SQL SERVER® database, and MICROSOFT® Commerce Server. Additionally, components such as ACCESS® software, SQL SERVER® database, ORACLE® software, SYBASE® software, INFORMIX® software, MYSQL® software, INTERBASE® software, etc., may be used to provide an Active Data Object (ADO) compliant database management system. In one embodiment, the APACHE® web server is used in conjunction with a LINUX® operating system, a MYSQL® database, and PERL®, PHP, Ruby, and/or PYTHON® programming languages.

For the sake of brevity, conventional data networking, application development, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

In various embodiments, the system and various components may integrate with one or more smart digital assistant technologies. For example, exemplary smart digital assistant technologies may include the ALEXA® system developed by the AMAZON® company, the GOOGLE HOME® system developed by Alphabet, Inc., the HOMEPOD® system of the APPLE® company, and/or similar digital assistant technologies. The ALEXA® system, GOOGLE HOME® system, and HOMEPOD® system, may each provide cloud-based voice activation services that can assist with tasks, entertainment, general information, and more. All the ALEXA® devices, such as the AMAZON ECHO®, AMAZON ECHO DOT®, AMAZON TAP®, and AMAZON FIRE® TV, have access to the ALEXA® system. The ALEXA® system, GOOGLE HOME® system, and HOMEPOD® system may receive voice commands via its voice activation technology, activate other functions, control smart devices, and/or gather information. For example, the smart digital assistant technologies may be used to interact with music, emails, texts, phone calls, question answering, home improvement information, smart home communication/activation, games, shopping, making to-do lists, setting alarms, streaming podcasts, playing audiobooks, and providing weather, traffic, and other real time information, such as news. The ALEXA®, GOOGLE HOME®, and HOMEPOD® systems may also allow the user to access information about eligible transaction accounts linked to an online account across all digital assistant-enabled devices.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, UNIX®, LINUX®, SOLARIS®, MACOS®, etc.) as well as various conventional support software and drivers typically associated with computers.

The present system or any part(s) or function(s) thereof may be implemented using hardware, software, or a combination thereof and may be implemented in one or more computer systems or other processing systems. However, the manipulations performed by embodiments may be referred to in terms, such as matching or selecting, which are commonly associated with mental operations performed by a human operator. No such capability of a human operator is necessary, or desirable, in most cases, in any of the operations described herein. Rather, the operations may be machine operations or any of the operations may be conducted or enhanced by artificial intelligence (AI) or machine learning. AI may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

In various embodiments, the embodiments are directed toward one or more computer systems capable of carrying out the functionalities described herein. The computer system includes one or more processors. The processor is connected to a communication infrastructure (e.g., a communications bus, cross-over bar, network, etc.). Various software embodiments are described in terms of this exemplary computer system. After reading this description, it will become apparent to a person skilled in the relevant art(s) how to implement various embodiments using other computer systems and/or architectures. The computer system can include a display interface that forwards graphics, text, and other data from the communication infrastructure (or from a frame buffer not shown) for display on a display unit.

The computer system also includes a main memory, such as random access memory (RAM), and may also include a secondary memory. The secondary memory may include, for example, a hard disk drive, a solid-state drive, and/or a removable storage drive. The removable storage drive reads from and/or writes to a removable storage unit in a well-known manner. As will be appreciated, the removable storage unit includes a computer usable storage medium having stored therein computer software and/or data.

In various embodiments, secondary memory may include other similar devices for allowing computer programs or other instructions to be loaded into a computer system. Such devices may include, for example, a removable storage unit and an interface. Examples of such may include a program cartridge and cartridge interface (such as that found in video game devices), a removable memory chip (such as an erasable programmable read only memory (EPROM), programmable read only memory (PROM)) and associated socket, or other removable storage units and interfaces, which allow software and data to be transferred from the removable storage unit to a computer system.

The terms “computer program medium,” “computer usable medium,” and “computer readable medium” are used to generally refer to media such as removable storage drive and a hard disk installed in hard disk drive. These computer program products provide software to a computer system.

The computer system may also include a communications interface. A communications interface allows software and data to be transferred between the computer system and external devices. Examples of such a communications interface may include a modem, a network interface (such as an Ethernet card), a communications port, etc. Software and data transferred via the communications interface are in the form of signals which may be electronic, electromagnetic, optical, or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

In various embodiments, the server may include application servers (e.g., WEBSPHERE®, WEBLOGIC®, JBOSS®, POSTGRES PLUS ADVANCED SERVER®, etc.). In various embodiments, the server may include web servers (e.g., Apache, IIS, GOOGLE® Web Server, SUN JAVA® System Web Server, JAVA® Virtual Machine running on LINUX® or WINDOWS® operating systems).

A web client includes any device or software which communicates via any network, such as, for example any device or software discussed herein. The web client may include internet browsing software installed within a computing unit or system to conduct online transactions and/or communications. These computing units or systems may take the form of a computer or set of computers, although other types of computing units or systems may be used, including personal computers, laptops, notebooks, tablets, smart phones, cellular phones, personal digital assistants, servers, pooled servers, mainframe computers, distributed computing clusters, kiosks, terminals, point of sale (POS) devices or terminals, televisions, or any other device capable of receiving data over a network. The web client may include an operating system (e.g., WINDOWS®, WINDOWS MOBILE® operating systems, UNIX® operating system, LINUX® operating systems, APPLE® OS® operating systems, etc.) as well as various conventional support software and drivers typically associated with computers. The web-client may also run MICROSOFT® INTERNET EXPLORER® software, MOZILLA® FIREFOX® software, GOOGLE CHROME′ software, APPLE® SAFARI® software, or any other of the myriad software packages available for browsing the internet.

As those skilled in the art will appreciate, the web client may or may not be in direct contact with the server (e.g., application server, web server, etc., as discussed herein). For example, the web client may access the services of the server through another server and/or hardware component, which may have a direct or indirect connection to an internet server. For example, the web client may communicate with the server via a load balancer. In various embodiments, web client access is through a network or the internet through a commercially-available web-browser software package. In that regard, the web client may be in a home or business environment with access to the network or the internet. The web client may implement security protocols such as Secure Sockets Layer (SSL) and Transport Layer Security (TLS). A web client may implement several application layer protocols including HTTP, HTTPS, FTP, and SFTP.

The various system components may be independently, separately, or collectively suitably coupled to the network via data links which includes, for example, a connection to an Internet Service Provider (ISP) over the local loop as is typically used in connection with standard modem communication, cable modem, DISH NETWORK®, ISDN, Digital Subscriber Line (DSL), or various wireless communication methods. It is noted that the network may be implemented as other types of networks, such as an interactive television (ITV) network. Moreover, the system contemplates the use, sale, or distribution of any goods, services, or information over any network having similar functionality described herein.

The system contemplates uses in association with web services, utility computing, pervasive and individualized computing, security and identity solutions, autonomic computing, cloud computing, commodity computing, mobility and wireless solutions, open source, biometrics, grid computing, and/or mesh computing.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT® programs, active server pages (ASP), common gateway interface scripts (CGI), extensible markup language (XML), dynamic HTML, cascading style sheets (CSS), AJAX (Asynchronous JAVASCRIPT And XML) programs, helper applications, plug-ins, and the like. A server may include a web service that receives a request from a web server, the request including a URL and an IP address (192.168.1.1). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. For example, representational state transfer (REST), or RESTful, web services may provide one way of enabling interoperability between applications.

The computing unit of the web client may be further equipped with an internet browser connected to the internet or an intranet using standard dial-up, cable, DSL, or any other internet protocol known in the art. Transactions originating at a web client may pass through a firewall in order to prevent unauthorized access from users of other networks. Further, additional firewalls may be deployed between the varying components of CMS to further enhance security.

Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, Triple DES, Blowfish, AES, MD5, HMAC, IDEA, RC6, and symmetric and asymmetric cryptosystems. The systems and methods may also incorporate SHA series cryptographic methods, elliptic curve cryptography (e.g., ECC, ECDH, ECDSA, etc.), and/or other post-quantum cryptography algorithms under development.

The firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the internet. A firewall may be integrated as software within an internet server or any other application server components, reside within another computing device, or take the form of a standalone hardware component.

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, N.Y.), various database products available from ORACLE® Corporation (Redwood Shores, Calif.), MICROSOFT ACCESS® or MICROSOFT SQL SERVER® by MICROSOFT® Corporation (Redmond, Wash.), MYSQL® by MySQL AB (Uppsala, Sweden), MONGODB®, Redis, APACHE CASSANDRA®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); data stored as Binary Large Object (BLOB); data stored as ungrouped data elements encoded using ISO/IEC 7816-6 data elements; data stored as ungrouped data elements encoded using ISO/IEC Abstract Syntax Notation (ASN.1) as in ISO/IEC 8824 and 8825; other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with the system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored may be provided by a third party unrelated to the first and second party. Each of these three exemplary data sets may contain different information that is stored using different data storage formats and/or techniques. Further, each data set may contain subsets of data that also may be distinct from other subsets.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The data may be big data that is processed by a distributed computing cluster. The distributed computing cluster may be, for example, a HADOOP® software cluster configured to process and store big data sets with some of nodes comprising a distributed storage system and some of nodes comprising a distributed processing system. In that regard, distributed computing cluster may be configured to support a HADOOP® software distributed file system (HDFS) as specified by the Apache Software Foundation at www.hadoop.apache.org/docs.

As used herein, the term “network” includes any cloud, cloud computing system, or electronic communications system or method which incorporates hardware and/or software components. Communication among the parties may be accomplished through any suitable communication channels, such as, for example, a telephone network, an extranet, an intranet, internet, point of interaction device (point of sale device, personal digital assistant (e.g., an IPHONE® device, a BLACKBERRY® device), cellular phone, kiosk, etc.), online communications, satellite communications, off-line communications, wireless communications, transponder communications, local area network (LAN), wide area network (WAN), virtual private network (VPN), networked or linked devices, keyboard, mouse, and/or any suitable communication or data input modality. Moreover, although the system is frequently described herein as being implemented with TCP/IP communications protocols, the system may also be implemented using IPX, APPLETALK® program, IP-6, NetBIOS, OSI, any tunneling protocol (e.g. IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet is generally known to those skilled in the art and, as such, need not be detailed herein.

Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

As used herein, “transmit” may include sending electronic data from one system component to another over a network connection. Additionally, as used herein, “data” may include encompassing information such as commands, queries, files, data for storage, and the like in digital or any other form.

Any communication, transmission, and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website, mobile application, or device (e.g., FACEBOOK®, YOUTUBE®, PANDORA®, APPLE TV®, MICROSOFT® XBOX®, ROKU®, AMAZON FIRE®, GOOGLE CHROMECAST™, SONY® PLAYSTATION®, NINTENDO® SWITCH®, etc.) a uniform resource locator (“URL”), a document (e.g., a MICROSOFT® Word or EXCEL™, an ADOBE® Portable Document Format (PDF) document, etc.), an “ebook,” an “emagazine,” an application or microapplication (as described herein), an short message service (SMS) or other type of text message, an email, a FACEBOOK® message, a TWITTER® tweet, multimedia messaging services (MMS), and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network, and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, LINKEDIN®, INSTAGRAM®, PINTEREST®, TUMBLR®, REDDIT®, SNAPCHAT®, WHATSAPP®, FLICKR®, VK®, OZONE®, WECHAT®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

Phrases and terms similar to an “item” may include any good, service, information, experience, entertainment, data, offer, discount, rebate, points, virtual currency, content, access, rental, lease, contribution, account, credit, debit, benefit, right, reward, points, coupons, credits, monetary equivalent, anything of value, something of minimal or no value, monetary value, non-monetary value and/or the like. Moreover, the “transactions” or “purchases” discussed herein may be associated with an item. Furthermore, a “reward” may be an item.

A “consumer profile” or “consumer profile data” may comprise any information or data about a consumer that describes an attribute associated with the consumer (e.g., a preference, an interest, demographic information, personally identifying information, and the like).

In various embodiments, an account number may identify a consumer. In addition, in various embodiments, a consumer may be identified by a variety of identifiers, including, for example, an email address, a telephone number, a cookie id, a radio frequency identifier (RFID), a biometric, and the like.

Phrases and terms similar to a “party” may include any individual, consumer, customer, group, business, organization, government entity, transaction account issuer or processor (e.g., credit, charge, etc.), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

As used herein, the term “end user,” “consumer,” “customer,” “cardmember,” “business,” or “merchant” may be used interchangeably with each other, and each shall mean any person, entity, government organization, business, machine, hardware, and/or software. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

The customer may be identified as a customer of interest to a merchant based on the customer's transaction history at the merchant, types of transactions, type of transaction account, frequency of transactions, number of transactions, lack of transactions, timing of transactions, transaction history at other merchants, demographic information, personal information (e.g., gender, race, religion), social media or any other online information, potential for transacting with the merchant, and/or any other factors.

Phrases and terms similar to “business” or “merchant” may be used interchangeably with each other and shall mean any person, entity, distributor system, software, and/or hardware that is a provider, broker, and/or any other entity in the distribution chain of goods or services. For example, a merchant may be a grocery store, a retail store, a travel agency, a service provider, an on-line merchant, or the like.

Phrases similar to a “payment processor” may include a company (e.g., a third party) appointed (e.g., by a merchant) to handle transactions. A payment processor may include an issuer, acquirer, authorizer, and/or any other system or entity involved in the transaction process. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction.

Phrases similar to a “payment gateway” or “gateway” may include an application service provider service that authorizes payments for e-businesses, online retailers, and/or traditional brick and mortar merchants. The gateway may be the equivalent of a physical point of sale terminal located in most retail outlets. A payment gateway may protect transaction account details by encrypting sensitive information, such as transaction account numbers, to ensure that information passes securely between the customer and the merchant and also between merchant and payment processor.

The disclosure and claims do not describe only a particular outcome of a persistent on demand payment system, but the disclosure and claims include specific rules for implementing the outcome of a persistent on demand payment system and that render information into a specific format that is then used and applied to create the desired results of a persistent on demand payment system, as set forth in McRO, Inc. v. Bandai Namco Games America Inc. (Fed. Cir. case number 15-1080, Sep. 13, 2016). In other words, the outcome of a persistent on demand payment system can be performed by many different types of rules and combinations of rules, and this disclosure includes various embodiments with specific rules. While the absence of complete preemption may not guarantee that a claim is eligible, the disclosure does not sufficiently preempt the field of a persistent on demand payment system at all. The disclosure acts to narrow, confine, and otherwise tie down the disclosure so as not to cover the general abstract idea of just persistent on demand payment system. Significantly, other systems and methods exist for persistent on demand payment system, so it would be inappropriate to assert that the claimed invention preempts the field or monopolizes the basic tools of persistent on demand payment system. In other words, the disclosure will not prevent others from a persistent on demand payment system, because other systems are already performing the functionality in different ways than the claimed invention. Moreover, the claimed invention includes an inventive concept that may be found in the non-conventional and non-generic arrangement of known, conventional pieces, in conformance with Bascom v. AT&T Mobility, 2015-1763 (Fed. Cir. 2016). The disclosure and claims go way beyond any conventionality of any one of the systems in that the interaction and synergy of the systems leads to additional functionality that is not provided by any one of the systems operating independently. The disclosure and claims may also include the interaction between multiple different systems, so the disclosure cannot be considered an implementation of a generic computer, or just “apply it” to an abstract process. The disclosure and claims may also be directed to improvements to software with a specific implementation of a solution to a problem in the software arts.

What is claimed is:

1. A method comprising:
creating, by a computer based system, a customizable payment event;
generating, by the computer based system, a first event token linked to the customizable payment event;
transmitting, by the computer based system, the first event token to a user device;
receiving, by the computer based system, at least one of a payment channel data or a dispute data; and
updating, by the computer based system, the customizable payment event based on at least one of the payment channel data or the dispute data.

2. The method of claim 1, further comprising:
receiving, by the computer based system, an invoice data;
determining, by the computer based system, a payable invoice based on the invoice data;
associating, by the computer based system, the payable invoice with a customer data;
determining, by the computer based system, a payable amount and a payable date based on the payable invoice and the customer data;
creating, by the computer based system, the customizable payment event in response to the payable invoice based on the customer data and the payable amount.

3. The method of claim 2, further comprising:
displaying, by the computer based system, a user configurable payment event settings interface;
receiving, by the computer based system, a payment event settings data; and
updating, by the computer based system, the customizable payment event based on the payment event settings data.

4. The method of claim 3, further comprising:
starting, by the computer based system, at least one of a payment schedule process or a payment change process in response to the payment event settings data;
generating, by the computer based system, a second event token linked to the customizable payment event and based on at least one of the payment schedule process or the payment change process.

5. The method of claim 3, further comprising:
capturing, by the computer based system, a payment event metadata;
evaluating, by the computer based system, the payment event metadata, the payment event settings data, and the customer data to determine a targeted payment event; and
generating, by the computer based system, a second event token linked to the customizable payment event and based on the targeted payment event.

6. The method of claim 3, wherein the payment event settings data includes at least one of a new payable date, a payment channel, a partial payment amount, or a reminder date.

7. The method of claim 1, further comprising:
receiving, by the computer based system, an autopayment enrollment confirmation;
starting, by the computer based system, an autopayment process in response to the autopayment enrollment confirmation;
generating, by the computer based system, a second event token via the autopayment process; and
executing, by the computer based system, a transaction based on the payment channel data.

8. A computer-based system, comprising:
a processor; and
a tangible, non-transitory memory configured to communicate with the processor, the tangible, non-transitory memory having instructions stored thereon that, in response to execution by the processor, cause the processor to perform operations comprising:
creating, by the processor, a customizable payment event;
generating, by the processor, a first event token linked to the customizable payment event;
transmitting, by the processor, the first event token to a user device;
receiving, by the processor, at least one of a payment channel data or a dispute data; and
updating, by the processor, the customizable payment event based on at least one of the payment channel data or the dispute data.

9. The computer based system of claim 8, wherein the operations further comprise:
receiving, by the processor, an invoice data;
determining, by the processor, a payable invoice based on the invoice data;
associating, by the processor, the payable invoice with a customer data;
determining, by the processor, a payable amount and a payable date based on the payable invoice and the customer data;
creating, by the processor, the customizable payment event in response to the payable invoice based on the customer data and the payable amount.

10. The computer based system of claim 9, wherein the operations further comprise:
displaying, by the processor, a user configurable payment event settings interface;
receiving, by the processor, a payment event settings data; and
updating, by the processor, the customizable payment event based on the payment event settings data.

11. The computer based system of claim 10, wherein the operations further comprise:
starting, by the processor, at least one of a payment schedule process or a payment change process in response to the payment event settings data;
generating, by the processor, a second event token linked to the customizable payment event and based on at least one of the payment schedule process or the payment change process.

12. The computer based system of claim 10, wherein the operations further comprise:
capturing, by the processor, a payment event metadata;
evaluating, by the processor, the payment event metadata, the payment event settings data, the customer data, and the invoice data to determine a targeted payment event; and
generating, by the processor, a second event token linked to the customizable payment event and based on the targeted payment event.

13. The computer based system of claim 10, wherein the payment event settings data includes at least one of a new payable date, a payment channel, a partial payment amount, or a reminder date.

14. The computer based system of claim 8, wherein the operations further comprise:
receiving, by the processor, an autopayment enrollment request;
starting, by the processor, an autopayment process in response to the autopayment enrollment request;
generating, by the processor, the first event token via the autopayment process; and
executing, by the processor, a transaction based on the payment channel data.

15. An article of manufacture including a non-transitory, tangible computer readable storage medium having instructions stored thereon that, in response to execution by a computer based system, cause the computer based system to perform operations comprising:
creating, by the computer based system, a customizable payment event;
generating, by the computer based system, a first event token linked to the customizable payment event;
transmitting, by the computer based system, the first event token to a user device;
receiving, by the computer based system, at least one of a payment channel data or a dispute data; and
updating, by the computer based system, the customizable payment event based on at least one of the payment channel data or the dispute data.

16. The article of manufacture of claim 15, wherein the operations further comprise:
receiving, by the computer based system, an invoice data;
determining, by the computer based system, a payable invoice based on the invoice data;
associating, by the computer based system, the payable invoice with a customer data;
determining, by the computer based system, a payable amount and a payable date based on the payable invoice and the customer data;
creating, by the computer based system, the customizable payment event in response to the payable invoice based on the customer data and the payable amount.

17. The article of manufacture of claim 16, wherein the operations further comprise:
displaying, by the computer based system, a user configurable payment event settings interface;
receiving, by the computer based system, a payment event settings data; and
updating, by the computer based system, the customizable payment event based on the payment event settings data.

18. The article of manufacture of claim 17, wherein the operations further comprise:
starting, by the computer based system, at least one of a payment schedule process or a payment change process in response to the payment event settings data;
generating, by the computer based system, a second event token linked to the customizable payment event and based on at least one of the payment schedule process or the payment change process.

19. The article of manufacture of claim 17, wherein the operations further comprise:
capturing, by the computer based system, a payment event metadata;
evaluating, by the computer based system, the payment event metadata, the payment event settings data, the customer data, and the invoice data to determine a targeted payment event; and
generating, by the computer based system, a second event token linked to the customizable payment event and based on the targeted payment event.

20. The article of manufacture of claim 15, wherein the operations further comprise:
receiving, by the computer based system, an autopayment enrollment request;
starting, by the computer based system, an autopayment process in response to the autopayment enrollment request;
generating, by the computer based system, the first event token via the autopayment process; and
executing, by the computer based system, a transaction based on the payment channel data.

21. A method comprising:
receiving, by a computer based system, a communication channel via an administrator portal;
associating, by the computer based system, the communication channel with a recipient device;
generating, by the computer based system, a first customizable payment event associated with a first event token;
transmitting, by the computer based system, the first event token via the communication channel;
receiving, by the computer based system, via a customer access point and in response to an interaction by the recipient device with the first event token a payment channel data;
receiving, by the computer based system, via a customer access point a first payment authorization; and
executing, by the computer based system, a first transaction based on the payment channel data.

22. The method of claim 21, further comprising:
generating, by the computer based system, a second customizable payment event associated with a second event token;
transmitting, by the computer based system, the second event token via the communication channel;
receiving, by the computer based system, via a customer access point a second payment authorization;
authenticating, by the computer based system, the second payment authorization based on the communication channel and the second payment authorization; and
executing, by the computer based system, a second transaction based on the payment channel data.

23. The method of claim 2, wherein the payable invoice is determined in response to at least one of an exclude flag or an available to be paid flag of the invoice data.

24. The computer based system of claim 9, wherein the payable invoice is determined in response to at least one of an exclude flag or an available to be paid flag of the invoice data.

25. The article of manufacture of claim 16, wherein the payable invoice is determined in response to at least one of an exclude flag or an available to be paid flag of the invoice data.
